(19) United States
(12) Patent Application Publication
(10) Pub. No.: US 2004/0103308 A1
(43) Pub. Date: May 27, 2004

(54) Self-configuring protocol gateway

(76) Inventor: Gabor Paller, (US)

Correspondence Address: CRAWFORD PLLC, Suite 390, 1270 Northland Drive, St. Paul, MN, 55120, US

(21) Appl. No.: 10/304,452

(22) Filed: Nov. 25, 2002

(51) Int. Cl. H04L 9/00

(52) U.S. Cl. 713/201

(57) ABSTRACT

Systems and methods are provided for automatically configuring a gateway to allow access to a network element through a public access communication network. Automatic configuration of the gateway involves identifying the network or device to be accessed using a service registry. The location of configuration files for configuring the gateway is transferred to the gateway as part of the identification process. The gateway automatically accesses and installs the configuration files. Installation of the configuration files on the gateway configures the gateway to provide access between the network element and terminals connected to the gateway through a public access communication network.

### FIELD OF THE INVENTION

The present invention relates generally to network communications systems, and more particularly, to a system and method for automatically configuring a mobile network protocol gateway.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. The proliferation of local, regional, and global networks such as the Internet has availed a sea of information to society. These networking technologies have expanded to increasingly include wireless and mobile technologies. Through these networks, information can be downloaded to desktop systems, wireless systems, mobile systems, etc. For example, information available via the Internet can now be downloaded onto mobile wireless units, such as cellular telephones, personal digital assistants (PDAs), laptop computers, etc. One such technology facilitating the transfer of Internet content to and from wireless devices is the Wireless Application Protocol (WAP), which integrates the Internet and other networks with wireless network platforms. Generally, WAP is a set of protocols that accounts for characteristics and functionality of both Internet standards and standards for wireless services. It is independent of wireless network standards, and is designed as an open standard. WAP bridges the gap between the wireline Internet paradigm and the wireless domain, to allow wireless device users to enjoy the benefits of the Internet across both platforms.

Second generation wireless service, often referred to as 2G wireless service, is a current wireless service based on circuit-switched technology. 2G systems, such as Global System for Mobile communications (GSM) and Personal Communications Services (PCS), use digital radio technology for improved quality and a broader range of services over first generation mobile technologies. 3G, or third generation, refers to a set of digital technologies that promises improvements in capacity, speed and efficiency by deploying new packet-based transmission methodologies between terminals and the network. Users of 3G devices and networks will have access to multimedia services such as video-on-demand, video conferencing, fast web access and file transfer. Existing and future services are, and will continue to be, provided by network service operators who make services and applications available to mobile device users via the network.

With the introduction of new mobile services such as WAP, Multimedia Messaging Service (MMS), calendar and contact synchronization, as well as a multitude of other possibilities, the number of servers and portals providing services for mobile Internet terminals continues to expand. Further, there is an increasing number of features associated with these services, such as support for multimedia, location-based services, electronic payments, etc. Thus, mobile network systems supporting network technologies and mobile Internet services will continuously be taken into use, as new or replacement devices for existing subscribers. The new systems require new or updated configuration settings before they can successfully connect to the network servers that offer applications over the network.

### SUMMARY OF THE INVENTION

The present invention is directed to a system and method for automatically configuring a protocol gateway. In accordance with one embodiment of the invention, a method for automatically configuring a mobile services protocol gateway for operation with a network element includes identifying the network element to the gateway. The method further includes installing configuration files on the gateway to configure the gateway to allow access to the network element through the gateway.

Another embodiment of the invention involves a method for automatically configuring a mobile network gateway for operation with a secure network. According to this method, a location reference pointing to the location of configuration files associated with the secure network is registered in a service registry. The location reference of the configuration files is provided to the mobile network gateway. Using the location reference, the mobile network gateway accesses and downloads the configuration files. The mobile network gateway installs the configuration files, thus configuring the mobile network gateway to allow access to the secure network.

Another embodiment of the invention provides an automatic gateway configuration system. The system includes a gateway arranged to provide access to a network element coupled to the gateway. The system further includes a service registry coupled to the gateway and arranged to identify the network element to the gateway. Configuration files associated with the network element are installed on the gateway to configure the gateway to allow access to the network element through the gateway.

In accordance with another embodiment of the invention, a system for automatically configuring a network gateway for operation with a network element includes means for identifying the network element to the gateway and means for installing configuration information on the gateway for allowing access to the network element through the gateway.

In accordance with yet another embodiment of the invention, a system for automatically configuring a mobile network gateway for operation with a secure network comprises means for registering a location reference of configuration files associated with the secure network in a service registry, means for providing the location reference of the configuration files to the mobile network gateway, and means for downloading the configuration files to the mobile network gateway using the location reference. The system further includes installation means for installing the configuration files on the mobile network gateway to configure the mobile network gateway for operation with the secure network.

Another embodiment of the invention involves a computer-readable medium having computer-executable instructions for automatically configuring a gateway for operation with a network element. The computer-executable instructions perform steps including identifying the network element to the gateway and installing configuration information on the gateway, the configuration information allowing access to the network element through the gateway.

The above summary of the present invention is not intended to describe each illustrated embodiment or implementation of the present invention. This is the purpose of the figures and the associated discussion which follows.

### BRIEF DESCRIPTION OF THE DRAWINGS

The invention is described in connection with the embodiments illustrated in the following diagrams.

FIG. 1 illustrates a general network architecture through which the principles of the present invention may be applied;

FIG. 2 is a block diagram illustrating a system for automatically configuring a protocol gateway in accordance with an embodiment of the invention;

FIG. 3 is a flowchart illustrating a method for automatically configuring a protocol gateway to allow access to a network element through a public access network in accordance with an embodiment of the invention; and

FIGS. 4 and 5 are communication flow diagrams illustrating communication flows associated with configuring a protocol gateway for operation with a network element in accordance with an embodiment of the invention.

### DETAILED DESCRIPTION OF THE ILLUSTRATED EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

Within the general framework of network communications, it is often desirable to provide access to a secure or controlled access network or system by users connected through a publicly accessible network structure. Such an arrangement may be used, for example, to allow a selected group of users to access a secure network for retrieving private data or conducting secure transactions. These types of transactions involve systems that can discern and allow communications from authorized users and rebuff communications from unauthorized users. Furthermore, the transactions of a secure system may be protected from public scrutiny using a variety of data protection schemes, including, for example, encryption/decryption of messages. Accessing a secure network or system through a publicly accessible network may be complicated due to differences in the communication protocols used by the different networks. In these example situations, a gateway device may be used to provide secure access and protocol conversion between the publicly accessible network and the secure network or system.

The present invention involves systems and methods for automatically configuring a gateway to allow access to a secure network or device through a public access communication network. Previous configuration methods involved manual configuration of the gateway for each network element utilizing a different interface or communication protocol. Automatic configuration of the gateway according to the principles of the invention provides faster service set up and decreased chance for erroneous configuration when compared to previous manual configuration techniques.

According to the principles of the invention, automatic configuration of the gateway involves identifying the secure network or device to be accessed using a service registry. In accordance with various embodiments, identification of the secure network or device to be accessed includes transmitting to the gateway a location reference used to access files for configuring the gateway. The files for configuring the gateway are denoted herein as configuration files. The configuration files include, for example, computer code to be executed on the gateway to implement functions involving secure access and/or protocol conversion, as well as files to allow the computer code to integrate with the gateway's software.

Using the location reference, the gateway automatically accesses and installs the configuration files. Installation of the configuration files on the gateway configures the gateway to provide access between the secure network or other device and terminals connected to the gateway through a public access communication network.

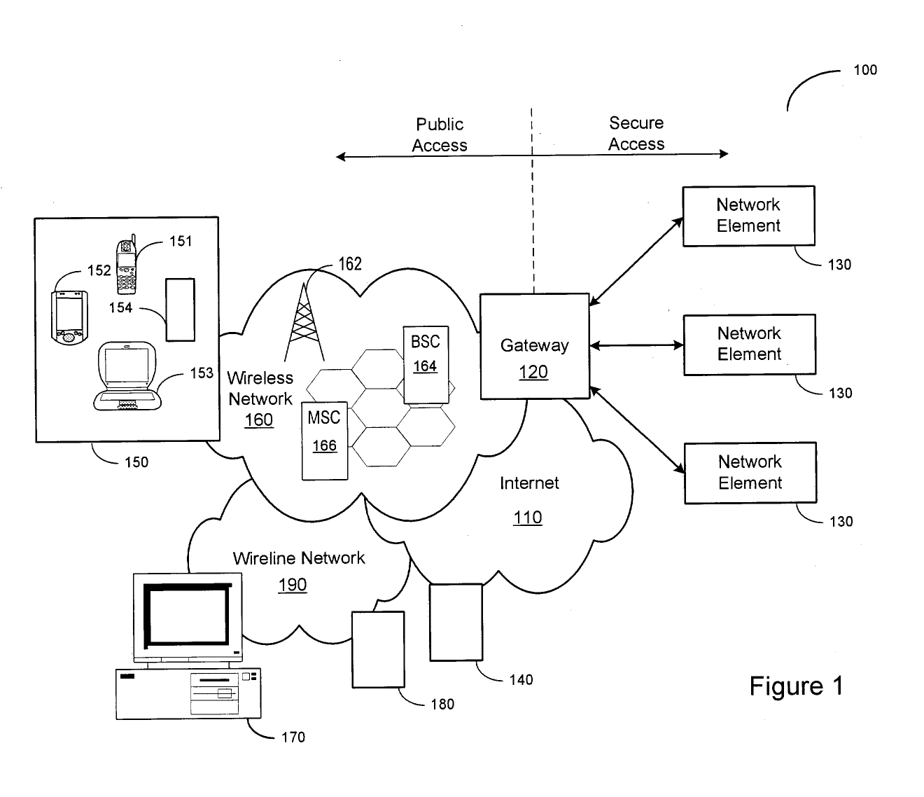

FIG. 1 illustrates a general network architecture 100 providing an environment in which the principles of the present invention may be applied. The exemplary environment of FIG. 1 illustrates a mobile telecommunications network architecture that may be used, for example, in connection with a Global System for Mobile Communications (GSM) such as General Packet Radio System (GPRS). The invention is equally applicable to other technologies and network structures.

Referring to FIG. 1, a wireless terminal 150 communicates with a base transceiver station 162 via an air interface. The base station transceiver 162 is a component of a wireless network access infrastructure that terminates the air interface over which subscriber traffic is communicated to and from the terminal 150. A base station controller 164 is a switching module that provides, among other things, handoff functions, and controls power levels in each base station transceiver 162. The base station controller 164 controls the interface between a mobile switching center 166 and one or more base station transceivers 162 in a GSM mobile wireless network, and thus controls one or more base station transceivers 162 in the call set-up functions, signaling, and in the use of radio channels.

In addition to basic services involving mobile communications between customers, mobile service providers may also provide network-based, e.g., internet-based, services to their customers by integrating accessibility to a variety of third party data services into their mobile services portfolio. These data services, referred to as web services for mobile terminals, may be made interoperable and integrated allowing the customer to use a number of network-based services.

Wireless terminal users may gain access to a variety of on-line web services applications 140 using a gateway device 120. Web services may be accessed directly through a gateway 120, or through an intermediary application, such as a Service Provide Interface application (SPI App).

Web services are typically network-based (particularly Internet-based) modular applications that each perform a specific task and conform to a specific technical format. Web services are represented by a stack of emerging standards that collectively provide a distributed computing environment for delivering services across the Internet. Using the web services infrastructure, a variety of applications can be implemented by the customer, ranging from simple requests to complicated business processes. For example, a user may link an address with driving directions and traffic conditions to obtain an estimated trip time. In another example, an e-commerce purchaser may coordinate a number of services, including services directed to purchasing, shipping, financing, and insuring the e-commerce purchased product.

Web services may be accessed via ubiquitous Web protocols and data formats, such as Hypertext Transfer Protocol (HTTP), Simple Object Access Protocol (SOAP), and Extensible Markup Language (XML). XML is a text-based markup language that is currently used extensively for data interchange on the Web. XML is a language that allows complex interactions between clients and services, as well as between components of a composite service, to be expressed. HTTP is an application protocol, and more particularly is a set of rules for exchanging files (text, graphic images, sound, video, and other multimedia files) on a network such as the World Wide Web. SOAP is a protocol specification that defines a uniform manner of passing XML-encoded data, and also defines a manner to perform remote application access using HTTP as the underlying communication protocol.

A gateway device 120 may be used to provide web services access to secure network elements 130. Such a gateway 120, denoted herein as a protocol gateway, provides access between the terminals 150, 170, 180 and the network elements 130 coupled to the public access network 160, 110, 190. In the example of FIG. 1, the protocol gateway function is described as being combined with the web services gateway function within a generic gateway device 120. It will be apparent to one skilled in the art that the protocol gateway and the web services gateway represent functions that may be arranged in various configurations. Specifically, the web services and protocol gateway functions may be represented as combined within a single functional block or as separate functional blocks.

In this application, one side of the protocol gateway 120 is accessible through the public access network 160, 110, 190, whereas the other side of the protocol gateway 120 represents a secure network environment with controlled access to the network elements 130. The protocol gateway 120 may perform functions involving both controlling access to the secure networks 130 and adapting a communication protocol translation between a public access network 160, 190, 110 and the secure networks 130.

In the exemplary architecture illustrated by FIG. 1, a wireless device 150 or a wireline device 170, 180 may access one or more network elements 130 through cooperating publicly access networks 160, 190, 110. The network architecture illustrated in FIG. 1 serves to couple wireless mobile terminals 150 and stationary terminals 170, 180 to various information systems, e.g., network-based e-business or email servers, and/or secure network systems 130. This level of connectivity facilitates information transfer between a wide variety of networked devices.

As illustrated in FIG. 1 a wireless terminal 150, may include any type of mobile communication device. For example, the wireless terminal 150 may include a personal digital assistant (PDA) 152, a wirelessly connected notebook or laptop computer 153, a cellular telephone 151, or any other type of wireless terminal represented by generic wireless device 154. One or more of these devices may be coupled through a wireless network 160 to network elements 130 through a gateway 120, as illustrated in FIG. 1. In addition, one or more wireline networked workstations 170 or other type of wireline-connected device 180 may also be coupled to the protocol gateway 120 and used to access the network elements 130.

Exchanging information between the wireless or wireline terminals 150, 170, 180 and the network elements 130 coupled through the gateway 120 involves configuration of the gateway 120 to provide access to the network elements 130. In one example, a network element 130 represents a secure network providing for secure communications between the network element 130 and selected users. In this configuration, the gateway 120 may limit or control access to the network element application with respect to selected users. In addition, the gateway 120 may provide encryption/decryption communication functions between the terminal 150 and the network element 130.

The gateway 120 illustrated in FIG. 1 may also be used to provide communication protocol translation between a wireless terminal 150 coupled through a public access network 160 190, 110 to the network element 130. The protocol gateway 120 presents a unified application protocol on the public access side of the gateway 120 and a potentially different protocol on the private side of the gateway 120. Protocol conversion between disparate systems allows the wireless or wireline terminal user to access a variety of systems and resources using a universal language and framework, thus simplifying communications at the terminal.

The public access side of a protocol gateway 120 may accomplish data transfers using a SOAP interface, for example, whereas the private side of a protocol gateway 120 may operate using a proprietary protocol of the network element 130. Access to a network element 130 through a protocol gateway 120 makes use of software components and configuration data installed at the protocol gateway 120 to implement the communication protocol conversion. If the applications of a particular network element are not accessible through the protocol gateway 120, there should not be an accessible public access interface, e.g., SOAP interface to that network element 130. Access to the applications of a network element 130 involves configuration of the protocol gateway 120 to allow synchronization between the operations of the protocol used by the public access network and the protocol of the network element.

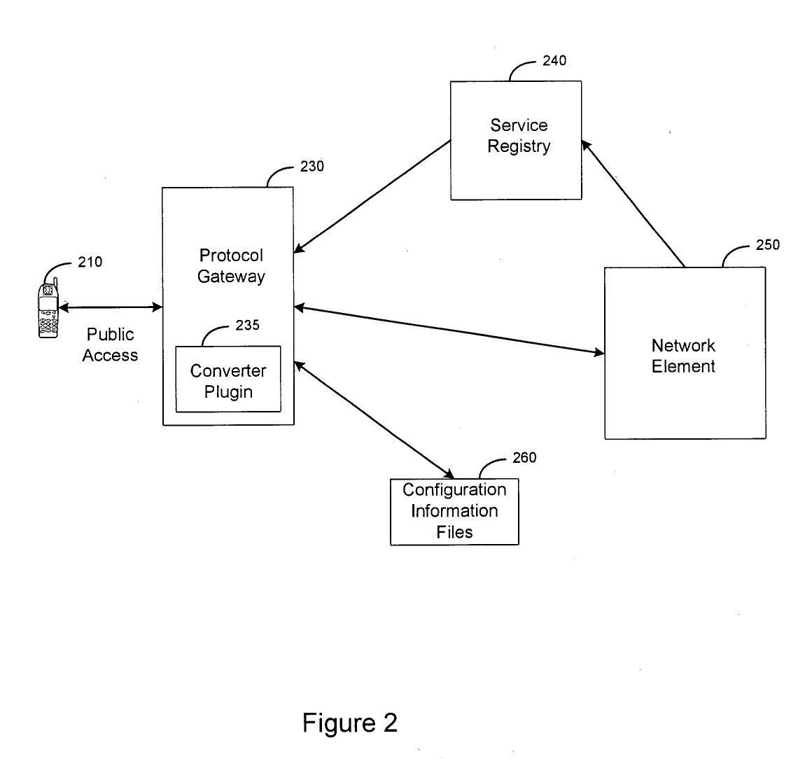

According to various embodiments of the invention, methods and systems for automatically configuring a protocol gateway for use with one or more network elements is provided. FIG. 2 illustrates a system for configuring access to a network element 250 through a protocol gateway 230 in accordance with an embodiment of the invention. According to this approach, the protocol gateway 230 may be configured automatically to allow a mobile services terminal 210 to access a network element 250 through the protocol gateway 230.

As illustrated in FIG. 2, one or more mobile terminals 210 may be coupled through a public access network to a gateway 230, e.g. a protocol gateway that may also optionally incorporate the functions of a web services gateway. A variety of systems may be accessed by the mobile terminal 210 through the gateway 230 via the public access network, including, in this example, one or more secure network elements 250. Various network elements 250 may be configured as secure networks, enabling the mobile services user to conduct e-commerce purchases or to access a private database through the mobile terminal 210, for example.

Before the gateway 230 can be used by the mobile terminal 210 to access the secure network element 250, the gateway 230 must be configured to operate with the network element 250. The configuration process involves installation of various protocol converter software components and configuration data at the gateway 230. Installation of the protocol converter software and configuration data enables the gateway 230 to provide access between the mobile terminal 210 and the network element 250. For example, configuration of the gateway 230 may allow the gateway 230 to control access to the network element 250 by limiting access to selected users. Alternatively, or additionally, configuration of the gateway 230 may allow the gateway 230 to translate between a public access protocol, such as a SOAP interface, and a private communication protocol of the secure network element 250.

In accordance with an embodiment of the invention, the various software components necessary for configuring the gateway 230, denoted herein as the configuration files 260, are accessible to the gateway 230 and may be automatically downloaded and installed by the gateway 230. The configuration files 260 may stored at the network element 250, or at other storage locations accessible by the gateway 230.

Configuration of a gateway 230 for use with a network element 250, in accordance with an embodiment of the invention, involves the operation of a service registry for the mobile network. The service registry 240 stores information about one or more network elements 250 available to the mobile network user.

The mobile network's service registry may utilize a technology such as Universal Discovery, Description, and Integration (UDDI) for registering network elements 250 available to the mobile network's users. Such a registry technology provides may be used to implement an online “yellow pages” for the mobile network service registry allowing users to dynamically locate various applications, including those of the network elements 250. The service registry may be implemented using a standard set of protocols providing a directory of information regarding the network elements 250 available to the mobile network customer.

In accordance with the principles of the invention, information stored in the mobile network's service registry 240 includes a location reference, e.g., a uniform resource locator (URL), pointing to the location of configuration files 260 that may be used to configure the gateway 230 for use with a particular network element 250. The configuration files may include, for example, software representing a protocol converter module 235 to implement protocol conversion between the public access network and the network element 250.

The configuration files 260 may also include data files describing the network element interface. For example, the interface files may describe the capabilities of the network element, e.g., what it can do, where it resides, and how to invoke it using a language such as web services description language (WSDL). WSDL is an XML-based description language defining how to connect to a particular site including in the basic format of service requests over different protocols or encodings.

Additionally, the configuration files may include access control files for controlling or limiting access to the network element to selected users. For example, the access control files may incorporate information to implement controlled access for gateway-to-network element communication, encryption/decryption programs, and other information to implement access control for the network element.

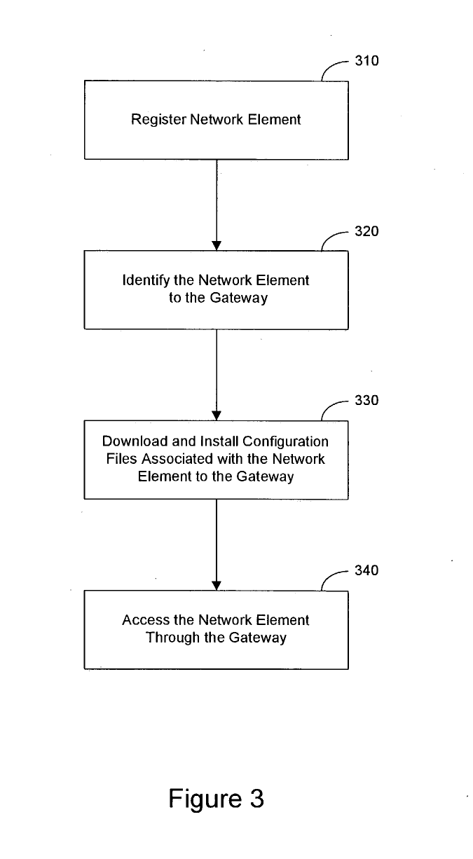

FIGS. 3-5 illustrate methods of automatically configuring a gateway to provide access to a network element. FIG. 3 is a flowchart illustrating a method for automatically configuring a publicly accessible protocol gateway to allow access through the gateway to a network element in accordance with an embodiment of the invention. By this exemplary method, various configuration information files located at the network element or elsewhere may be automatically installed for configuring the protocol gateway to allow access of the network elements.

Upon activation, a network element registers with a service registry 310. The service registry may be associated, for example, with a particular mobile network service. The registration process includes providing a location reference pointing to the location of the configuration files.

According to various embodiments of the invention, the service registry identifies 320 the network element to the gateway. According to one embodiment, the service registry may initiate the identification by sending a message to the protocol gateway to inform the protocol gateway of the existence of the network element. The message includes the location reference, i.e., URL, pointing to the location of the configuration files.

According to another embodiment, identification of the protocol gateway may be implemented by using the protocol gateway to periodically scan the service registry to detect network elements added to the registry. Upon detection of the added network element, identification information associated with the added network element, including the location reference of the configuration files, is transferred to the protocol gateway.

The protocol gateway accesses the configuration files using the location reference acquired during the identification process, downloads the configuration files and installs 330 the configuration files on the protocol gateway. Installation of the configuration files configures the protocol gateway to allow access between a mobile network user terminal and the secure network element. Requests for information transfer between a terminal and the network element are serviced 340 through the gateway.

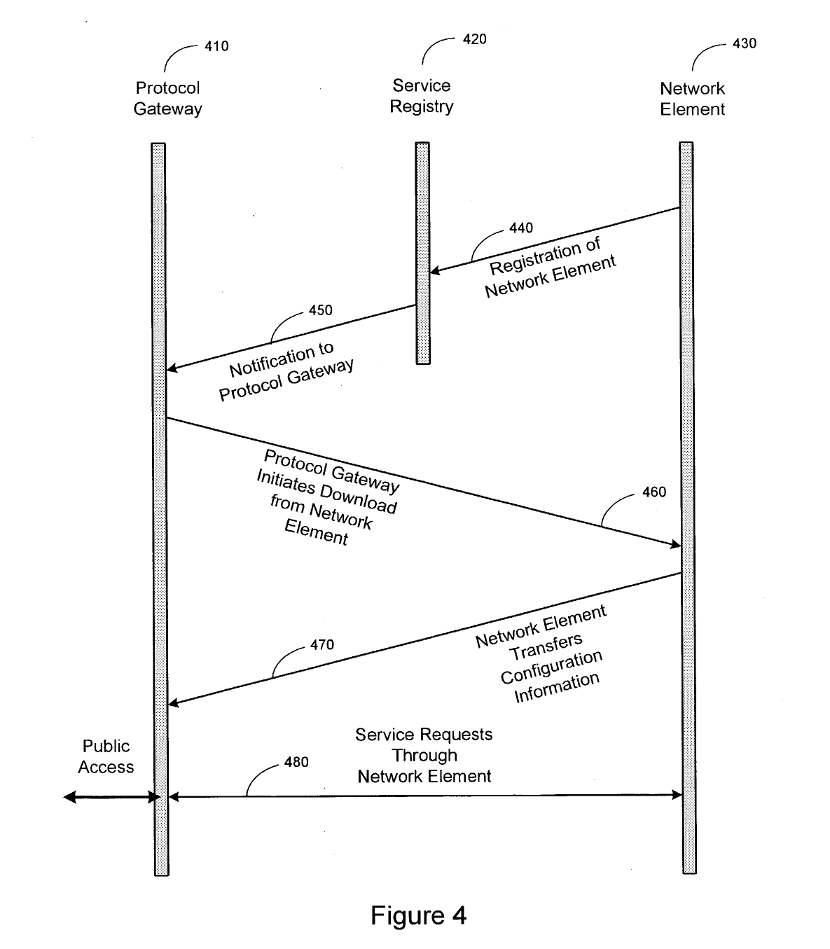

FIG. 4 is a communication flow diagram illustrating a communication flow associated with configuring a protocol gateway for operation with a network element in accordance with an embodiment of the invention. The system includes, at least, a protocol gateway 410, service registry 420, and network element 430.

When a network element 430 become available for use with a mobile services network, the network element 430 sends a registration message 440 to the internal service registry 420 of the mobile services network. The internal service registry 420 includes information regarding network elements available to supply services to users of the mobile network. In response to receiving the registration message 440 from the network element 430, the internal service registry 420 transmits a notification message 450 to the protocol gateway 410 regarding the presence of the network element 430. The notification message 450 includes a location reference, such as a URL, pointing to the location of configuration files required to configure the protocol gateway 410 for operation with the network element 430.

After receiving the notification message 450 from the service registry 420 regarding the network element 430, including the configuration file location reference, the protocol gateway 410 uses the location reference to initiate a download 460 of the configuration files. In this example, the configuration files are stored at the network element 430. Alternatively, the configuration files could be stored at a different location. The network element 430 transfers 470 the configuration files to the protocol gateway 410, including, for example, the converter module files, public interface files, and access control files, as described in more detail above. The protocol gateway 410 installs the configuration files and services requests 480 for access to the network element 430 through the protocol gateway 410.

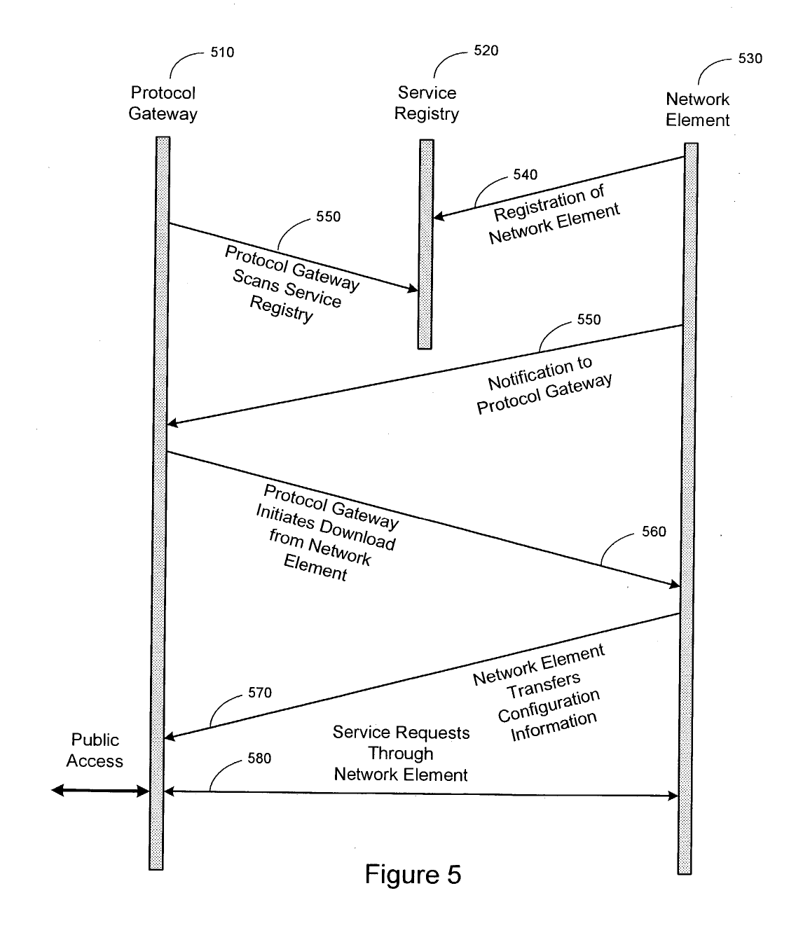

FIG. 5 illustrates another embodiment of the invention involving a method for automatically configuring the protocol gateway. According to this embodiment, the network element 530 registers 540 with the service registry 520 as previously described. The protocol gateway 510 periodically scans 550 the service registry 520 for updates to the registration information stored at the service registry 520. In response to detecting an added network element 530, the service registry 520 transmits a notification message 550 to the protocol gateway 510 regarding the network element 530. The notification message 550 includes a reference location pointing to the location of configuration files for configuring the protocol gateway 510.

The protocol gateway 510 uses the location reference to request and initiate 560 a download of the configuration files. In response to this request, the network element 530 transfers the configuration files to the protocol gateway 510. Installation of the configuration files at the protocol gateway 510 configures the protocol gateway 510 to service 580 requests for access to the network element 530 through the protocol gateway 510.

According to various embodiments of the invention described above, systems and methods are provided that enable a gateway to be automatically configured to allow access to a network element by a mobile network services user. Previous methods for configuring the protocol gateway involved manual configuration. The automatic configuration of the protocol gateway according to the principles of the invention provides faster service set up and decreased chance for erroneous configuration as compared to previous manual configuration techniques.

Using the foregoing specification, the invention may be implemented as a machine, process, or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts, may involve the use of a memory or transmitting device which only embodies program code transitorily as a preliminary or final step in making, using, or selling the invention.

Memory devices include, but are not limited to, hard disk drives, diskettes, optical disks, magnetic tape, semiconductor memories such as RAM, ROM, PROMS, etc. Transmitting devices include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

From the description provided herein, those skilled in the art are readily able to combine software created as described with appropriate general purpose or special purpose computer hardware to create a computer system and/or computer subcomponents embodying the invention, and to create a computer system and/or computer subcomponents for carrying out the method of the invention.

It will, of course, be understood that various modifications and additions can be made to the various embodiments discussed hereinabove without departing from the scope or spirit of the present invention. For example, the invention may be used in connection with any type of networking environment, ranging from local area networks to proliferative global area networks such as the Internet, and including cooperative landline and mobile networks. From the foregoing description of the illustrated embodiments, those of ordinary skill in the art will readily appreciate the applicability of the invention in any comparable network environment. Accordingly, the scope of the present invention should not be limited by the particular embodiments discussed above, but should be defined only by the claims set forth below and equivalents thereof.

What is claimed is:

1. A method for automatically configuring a mobile services protocol gateway for operation with a network element, comprising:
identifying the network element to the gateway; and
installing configuration files on the gateway, installation of the configuration files allowing access to the network element through the gateway.

2. The method of claim 1, wherein the gateway couples one or more secure networks to a public access network.

3. The method of claim 1, wherein identifying the network element comprises:
registering the network element with a service registry; and
transmitting a notification message from the service registry to the gateway regarding the network element.

4. The method of claim 1, wherein identifying the network element comprises providing a location reference associated with the configuration files.

5. The method of claim 4, wherein providing the location reference comprises providing a URL associated with the configuration files.

6. The method of claim 1, wherein identifying the network element comprises using a service registry to notify the gateway of the network element.

7. The method of claim 1, wherein identifying the network element comprises using the gateway to scan a service registry to identify the network element.

8. The method of claim 1, wherein installing the configuration files on the gateway comprises downloading the configuration files to the gateway.

9. The method of claim 8, wherein transferring the configuration files comprises downloading the configuration files from a storage location identified by a location reference.

10. The method of claim 9, wherein the location reference is a URL.

11. The method of claim 1, wherein the gateway comprises a gateway accessible through a mobile network.

12. The method of claim 1, wherein the network element comprises a secure network element.

13. A method for automatically configuring a mobile network gateway for operation with a secure network, comprising:
registering a location reference of configuration files associated with the secure network in a service registry;
providing the location reference of the configuration files to the mobile network gateway;
downloading the configuration files to the mobile network gateway using the location reference; and
installing the configuration files on the mobile network gateway to configure the mobile network gateway for operation with the secure network.

14. The method of claim 13, wherein providing the location reference comprises using the service registry to notifying the mobile network gateway of the secure network.

15. The method of claim 13, wherein providing the location reference comprises using the mobile network gateway to scan the service registry to identify the location reference.

16. The method of claim 13, wherein providing the location reference of the configuration files comprises providing a URL associated with the configuration files.

17. The method of claim 13, wherein downloading the configuration files to the mobile network gateway comprises downloading the configuration files from the secure network.

18. The method of claim 13, wherein installing the configuration files comprises installing protocol converter files used for converting a publicly accessible network protocol to a secure network protocol.

19. The method of claim 13, wherein installing the configuration files comprises installing files used for controlling access to the secure network.

20. An automatic gateway configuration system, comprising:
a gateway coupled to a network element;
a service registry coupled to the gateway and arranged to identify the network element to the gateway; and
configuration files used to automatically configure the gateway to allow access to the network element.

21. The system of claim 20, wherein the gateway couples a mobile network to the network element.

22. The system of claim 21, wherein the mobile network and the network element use different communication protocols.

23. The system of claim 20, wherein the configuration files comprise a protocol gateway converter for converting a mobile network protocol to a protocol allowing access to the network element.

24. The system of claim 20, wherein the configuration files comprise interface information for interfacing the network element to mobile terminals through the gateway.

25. The system of claim 20, wherein the configuration files comprise access information for controlling access to the network element through the gateway.

26. The system of claim 20, wherein the network element is configured to register with the service registry by providing network registration information to the service registry.

27. The system of claim 26, wherein the network registration information comprises a network location reference associated with the configuration files.

28. The system of claim 26 wherein the network registration information comprises a URL.

29. The system of claim 26, wherein the network registration information provides a location of the configuration files.

30. The system of claim 20, wherein the service registry is configured to identify the network element to the gateway by initiating a notification message to the gateway.

31. The system of claim 20, wherein the gateway is configured to scan the service registry to identify the network element.

32. The system of claim 20, wherein the gateway is configured to install the configuration files on the gateway and to provide access to the network element.

33. A system for automatically configuring a network gateway for operation with a network, comprising:
means for identifying the network element to the gateway; and
means for installing configuration files on the gateway, the configuration files allowing access to the network element through the gateway.

34. A system for automatically configuring a mobile network gateway for operation with a secure network, comprising:
means for registering a location reference of configuration files associated with the secure network in a service registry;
means for providing the location reference of the configuration files to the mobile network gateway;
means for downloading the configuration files to the mobile network gateway using the location reference; and
means for installing the configuration files on the mobile network gateway to configure the mobile network gateway for operation with the secure network.

35. A computer-readable medium having computer-executable instructions for automatically configuring a gateway for operation with a network element, the computer-executable instructions performing steps comprising:
identifying the network element to the gateway; and
installing configuration files on the gateway, the configuration files allowing access to the network element through the gateway.
